(19) United States
(12) Patent Application Publication
(10) Pub. No.: US 2026/0072570 A1
(43) Pub. Date: Mar. 12, 2026

(54) INFORMATION PROCESSING METHOD, ELECTRONIC DEVICE AND PROGRAM PRODUCT

(71) Applicant: Beijing Youzhuju Network Technology Co., Ltd., Beijing (CN)

(72) Inventors: Lin ZHU, Beijing (CN); Xiaojiao ZHONG, Beijing (CN)

(21) Appl. No.: 18/981,335

(22) Filed: Dec. 13, 2024

(30) Foreign Application Priority Data
Sep. 12, 2024 (CN) 202411280853.5

(51) Int. Cl. G06F 3/0482; H04N 21/2187; H04N 21/431; H04N 21/478

(52) U.S. Cl. CPC G06F 3/0482; H04N 21/2187; H04N 21/4312; H04N 21/47815

(57) ABSTRACT

According to the embodiments of the present disclosure, there are provided an information processing method, an electronic device, and a program product. The information processing method includes: displaying, on a first user interface, a list of items in a current live streaming channel; receiving a first user operation of adding an item in the list of items to a virtual container; and in response to the first user operation, displaying, at a bottom of the first user interface, an interactive element for the current live streaming channel, where the interactive element indicates that at least one item of the current live streaming channel has been added to the virtual container.

### CROSS REFERENCE TO RELATED APPLICATIONS

This application claims the priority to Chinese Application No. 202411280853.5 filed on Sep. 12, 2024, the disclosure of which is incorporated herein by reference in its entity.

### BACKGROUND

Live streaming shopping is a business model where live streaming is combined with e-commerce. On live streaming channels, anchors are shopping guides responsible for introducing various types of items in detail to viewers, specifically presenting the characteristics, advantages and usage of the items. The viewers could directly view the appearances, textures and actual use effects of the items through the live streaming screen. As compared with the legacy online shopping, the live streaming shopping is more interactive. On a live streaming channel, the viewers could jump in at any time if they have questions, while the anchor(s) could offer prompt answers thereto, eliminating their hesitations. Moreover, on the live streaming channels, the anchors often launch various limited-time promotions, free giveaways and raffle to encourage viewers'desire to make a purchase.

During live streaming shopping, users can directly purchase items of the current live streaming channel, or can add the items to a shopping cart and then enter the cart page for checkout when deciding to order. Market research has shown that most users are more likely to purchase items from the current live streaming channel over those already in the carts. This presents new challenges for live streaming shopping, particularly in terms of interface and interaction design.

### SUMMARY

In view of the above, embodiments of present disclosure provide an interface and a human-computer interaction design for live streaming shopping, which can display, to users, information about items added from the current live streaming channel.

In accordance with a first aspect of the present disclosure, there is provided an information processing method. The method comprises: displaying, on a first user interface, a list of items in a current live streaming channel; receiving a first user operation of adding an item in the list of items to a virtual container; and in response to the first user operation, displaying, at a bottom of the first user interface, an interactive element for the current live streaming channel, wherein the interactive element indicates that at least one item of the current live streaming channel has been added to the virtual container.

In accordance with a second aspect of the present disclosure, there is provided an electronic device, comprising: a processing unit; and a memory coupled to the processing unit and having instructions stored thereon, wherein the instructions, when executed by the processing unit, cause the electronic device to perform actions, the actions comprising: displaying, on a first user interface, a list of items in a current live streaming channel; receiving a first user operation of adding an item in the list of items to a virtual container; and in response to the first user operation, displaying, at a bottom of the first user interface, an interactive element for the current live streaming channel, wherein the interactive element indicates that at least one item of the current live streaming channel has been added to the virtual container.

In accordance with a third aspect of the present disclosure, there is provided a computer program product tangibly stored in a computer storage medium and comprising computer executable instructions, wherein the computer executable instructions, when executed by a device, cause the device to perform the following actions: displaying, on a first user interface, a list of items in a current live streaming channel; receiving a first user operation of adding an item in the list of items to a virtual container; and in response to the first user operation, displaying, at a bottom of the first user interface, an interactive element for the current live streaming channel, wherein the interactive element indicates that at least one item of the current live streaming channel has been added to the virtual container.

In accordance with a fourth aspect of the present disclosure, there is provided an information processing apparatus, comprising: a display unit configured to display, on a first user interface, a list of items in a current live streaming channel; and a user-operation receiving unit configured to receive a first user operation of adding an item in the list of items to a virtual container; wherein the display unit is further configured, in response to the first user operation, to display, at a bottom of the first user interface, an interactive element for the current live streaming channel, wherein the interactive element indicates that at least one item of the current live streaming channel has been added to the virtual container.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

FIG. 1A illustrates an example interface for live streaming shopping according to some embodiments of the present disclosure.

FIG. 1B illustrates an example interface for cart checkout according to some embodiments of the present disclosure.

FIG. 2 illustrates an example interface for live streaming shopping, which includes an interactive element for a current live streaming channel, according to some embodiments of the present disclosure.

FIG. 3 illustrates an example interface for cart checkout, which is switched from the interface shown in FIG. 2, according to some embodiments of the present disclosure.

FIG. 4 illustrates an example flowchart of an information processing method according to some embodiments of the present disclosure.

FIG. 5 illustrates an example block diagram of an information processing apparatus according to some embodiments of the present disclosure.

FIG. 6 illustrates a block diagram of an electronic device that can implement some embodiments of the present disclosure.

Throughout the drawings, the same or similar reference symbols refer to the same or similar components.

### DETAILED DESCRIPTION OF EMBODIMENTS

Reference now will be made to some example implementations to describe the present disclosure. As would be appreciated, those implementations are described only to enable those skilled in the art to better understand and thus implement the present disclosure, without suggesting any limitation to the scope of the present disclosure.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, nor formulating any limitation to the implementations of the present disclosure, and other methods compliant with the provisions of the relevant laws and regulations can also be applied to the implementations of the present disclosure.

Hereinafter, reference will be made to the accompanying drawings to describe in detail the embodiments of the present disclosure. Although some embodiments of the present disclosure are depicted in the drawings, it would be appreciated that the present disclosure could be implemented in various forms and should not be construed as being limited to the embodiments described herein. Rather, those embodiments are provided for a more thorough and complete understanding of the present disclosure. It is to be noted that the drawings and embodiments of the present disclosure are provided only exemplarily, rather than used for limiting the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

A smart phone is taken herein as an example to present an example user interface. However, those skilled in the art would appreciate that the embodiments of the present disclosure can also be applied to other devices having different aspect ratios, for example, tablets, laptops, desktop computers, wearable devices with screens, devices with foldable screens, and the like. In addition, the interfaces described herein are only provided illustratively, where some elements may be omitted or provided in a different number, and more elements not shown may also be included. Moreover, the interfaces according to the embodiments of the present disclosure may have different layouts than those shown in the drawings, and the respective elements may also be arranged at different positions. The present disclosure is not limited in those aspects.

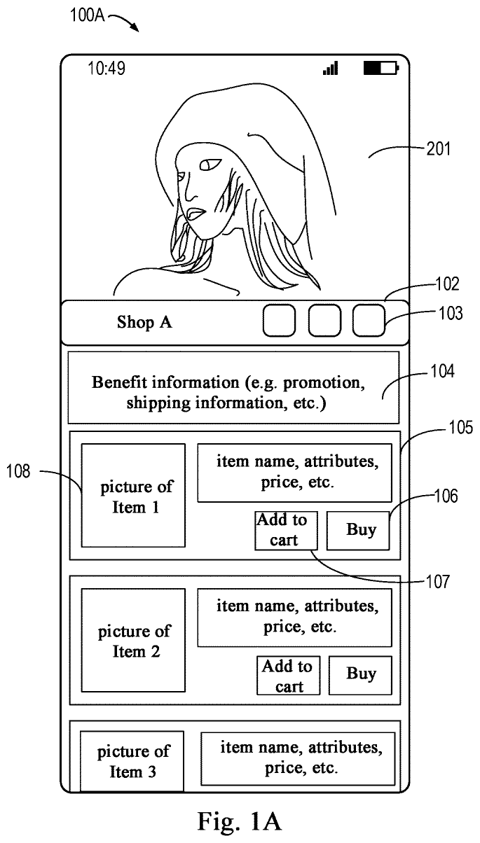

FIG. 1A illustrates an example interface 100A for live streaming shopping according to some embodiments of the present disclosure.

When a user participates in a live streaming shopping activity using an electronic device, the electronic device can display an interface 100A shown in FIG. 1. For example, the user may enter a live streaming channel via a video application on the electronic device, and watch the anchor describe items. In some implementations, the user may click a shopping icon on the screen to switch to the interface 100A, as shown in FIG. 1.

The interface 100A includes a live streaming area 201 where the user may watch the video stream from the current live streaming channel. The interface 100A further includes a navigation bar 102 that may include information about the current live streaming channel, and one or more interactive controls such as a cart icon 103. In some implementations, a total number of items in the cart may be displayed in or near the cart icon 103. In some implementations, additional information may also be displayed near the cart icon 103. For example, market information is displayed in the form of bubble(s). It is worth noting that the cart described herein includes items added by the user in the application, but not being limited to the items of the current live streaming channel.

Benefit information 104 about live streaming shopping is presented below the navigation bar 102. The benefit information 104 can arouse user interest to trigger shopping behaviors, which may be promotion information, shipping information (e.g. a reduced shipping fee, or free shipping), and the like.

The interface 100A further includes a list of items of the current live streaming channel. As shown therein, Item 1, Item 2, Item 3 or the like are supplied in the current live streaming channel. The user may swipe up and down on the interface 100A to browse more items. On the interface 100A, the area 105 includes related information of Item 1, including a picture 108 and a text description (e.g. name, attributes, price, and the like) of Item 1. In some implementations, the area 105 further includes one or more entries of benefit information (not shown) about Item 1.

The area 105 further includes a control 106 for directly purchasing the item, and a control 107 for adding the item to the cart. Upon deciding to add the item to the cart, the user may click or tap the control 106 to cause the interface 100A to switch to the checkout interface, and thus can purchase the item individually. In response to that the user clicks or taps the control 107, an animation of adding Item 1 to the cart, for example, an animation of the picture 108 of Item 1 flying into the cart icon 103, can be played on the interface 100A, and the number of items displayed in or near the cart icon 103, can be updated correspondingly, i.e., increased by 1.

Upon deciding to go to the cart for checkout, the user may click and tap the cart icon 103, to cause the interface 100A to switch to the example interface 100B for cart checkout as shown in FIG. 1B.

A list of all the items that have been added to the cart is displayed on the interface 100B, including the item of the current live streaming channel (shop A) displayed in the area 112, and an item, which is from a further live streaming channel (shop B) different from the current live streaming channel, displayed in the area 116. As shown therein, the interface 100B includes a control 111 for selecting all the items. When the user checks the control 111, all of the items in the cart are selected. For each item, the interface 100B further includes separate selection controls 113-1, 113-2, and 113-3, and a control 114 for adjusting the number of items to be purchased. In some implementations, none of the items are checked by default upon entering the interface 100B, as shown in FIG. 1B. Alternatively, all of the items may be checked by default, or items from one or more live streaming channels (e.g., live streaming channels that are browsed during this live shopping session) are checked, upon entering the interface 100B. After selecting items and setting the numbers, the user may click or tap a checkout control 115 for checking out.

The inventor has noticed the following issues. First of all, in the process of adding an item to the cart on the interface 100A described above and then switching from the interface 100A to the interface 100B for checking out, there lacks an effective manner for displaying, to the user, information (e.g. number, total price, promotion information, and the like) about items that are added from the current live streaming channel to the cart. Through marketing research, the inventor found that users are more likely to purchase items from the current live streaming channel when they make purchases through their carts, rather than through direct purchasing methods (e.g., by clicking or tapping the control 106). At this point, the information that captures most of the user's attention is information related to items that are added from the current live streaming channel to the cart. Therefore, the absence of the information about shopping in the current live streaming channel goes against user habits, thus leading to in a poor user experience. Second, only a limited space near the cart icon 103 is available on the interface 100A, which may obscure other marketing information, such as benefit information 104. As a result, there is insufficient information to guide users to the checkout interface for the cart. Thirdly, in the default state after entering the interface 200B, items from the current live streaming channel that are likely to capture most of the user's interest are not checked by default. However, users may change their mind when interacting with the interface 100B.

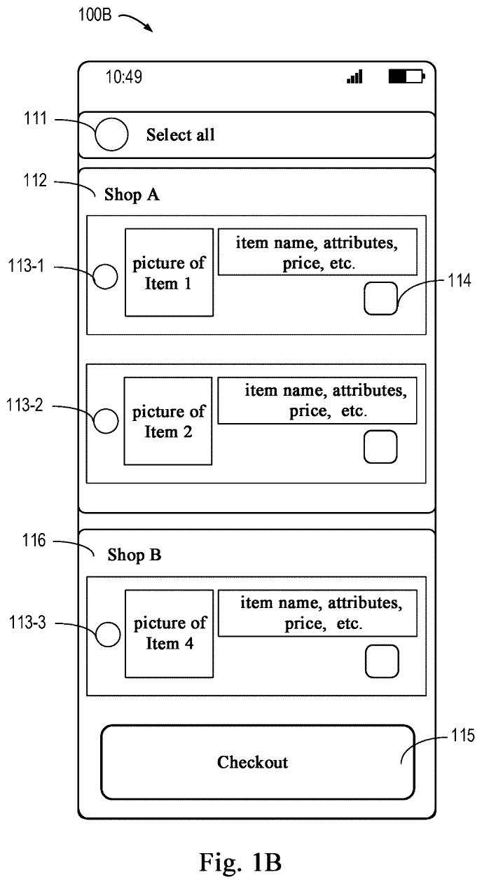

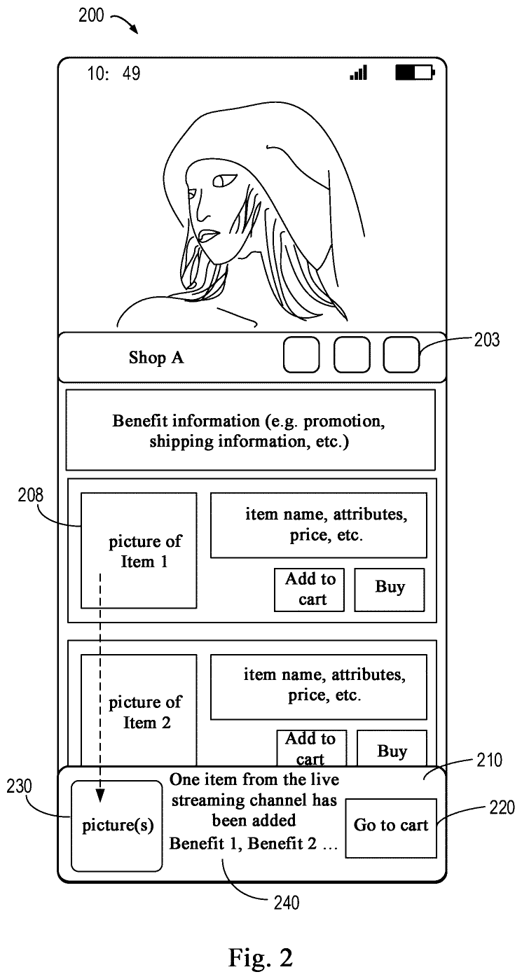

In view of the above, the present disclosure introduces a novel interface design and user interaction process that allow information about items added from the current live streaming channel to the cart to be presented to the user, thereby improving the user experience. Detailed descriptions will be provided with reference to FIGS. 2 and 3.

FIG. 2 illustrates an example interface 200 for live streaming shopping, which includes an interactive element 210 for the current live streaming channel, according to some embodiments of the present disclosure. In some embodiments, in response to a user clicking a control for adding an item of the current live streaming channel to the cart, for example, the control 107 on the interface 100A, the interface 200 may be displayed. For example, the interactive element 210 can slide in from the bottom of the interface 100A.

As shown therein, the interactive element 210 may be a bar element occupying the bottom of the interface 200. The interactive element 210 may be in other forms; for example, it may be displayed at other position of the interface 200, for example, the left side, the right side, or the top. The interactive element 210 may be of other geometric shapes, which is not limited herein.

The interactive element 210 indicates that at least one item of the current live streaming channel has been added to the cart. As shown therein, the interactive element 210 may include a picture 230 of the item of the current live streaming channel that has been added to the cart. If more than one items have been added to the cart, the pictures can be arranged in a partially overlapping manner. In some implementations, the picture of the most recently added item may be arranged on the top, which intuitively provides the user with the information about the items of the current live streaming channel that have been added to the cart. In some embodiments, when the interactive element 210 slides into the interface 200, an animation that the picture of the item (e.g. the picture 208 of Item 1) being added to the cart falls into the picture area 230 of the interactive element 210 can be played. This design better aligns with the intuitive feeling of an item being added to the cart.

The interactive element 210 may further include benefit information 240 in the form of text. The benefit information 240 may be used for arousing user interest to trigger the action of entering the cart page for consumption. In some embodiments, the benefit information 240 may include a total price, a number, promotion information, and/or shipping information (e.g. a shipping fee, whether to reduce or waive the shipping fee, or the like) of at least one item of the current live streaming channel that has been added to the cart. As compared with the cart picture 103 of the interface 100A, the interactive element 210 can provide a larger space for displaying additional information such as benefit information.

The interactive element 210 may include a control 220 (“Go to cart”) linked to the cart. Upon receiving an operation on the control 220, the interface 220 can be changed to an interface 300 as shown in FIG. 3. As shown therein, the interface 30 includes: a control 311 for selecting all the items in the cart, an area 312 for items of the current live streaming channel, and an area 316 for items of other live streaming channels, where individual selection controls 313-1, 313-2, 313-3 and number adjustment controls 314 for the items, and a checkout control 315 are provided. The interface 300 is generally similar to the interface 100B. However, in the initial state of the interface 300, the controls 313-1 and 313-2 for the items of the current live streaming channel are checked by default, and the control 313-3 for the item of the other live streaming channel is not checked by default. In this way, when the user enters the checkout interface 300 for the cart by clicking or tapping the control 220 on interface 200, all items from the current live streaming channel are automatically selected. This approach aligns with the user's purchasing expectations, encourages consumption, and facilitates a quicker checkout process.

Returning to FIG. 2, the interface 200 may include a cart icon 203. The user may click or tap the cart icon 203, to display the cart interface. On the cart interface displayed via the cart icon 203, all the items of the current live streaming channel are selected by default while the item of the other live streaming channel is not selected by default, as shown in FIG. 3. Alternatively, on the cart interface displayed via the cart icon 203, none of items are selected by default.

The interface design and interaction process for live streaming shopping according to the embodiments of the present disclosure have been described above with reference to FIG. 2, An element for the current live streaming channel is provided, and the picture and text information (including, but not limited to, the number, total price, benefits, and other details of the items) within the element are used to clearly display the information of the items of the current live streaming channel that have been added to the cart. In this way, the user can be effectively guided to the cart, thereby improving the user experience in the context of live streaming shopping.

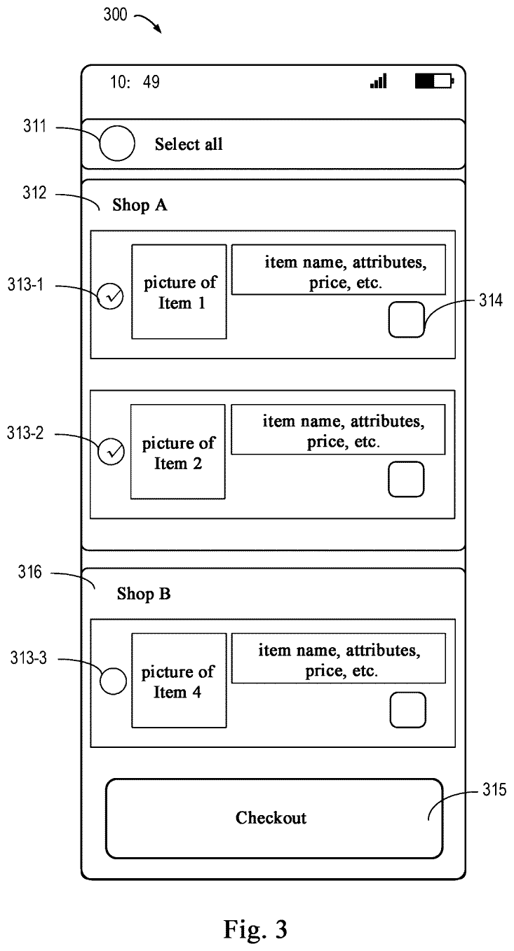

FIG. 4 illustrates a flowchart of an information processing method 400 according to some embodiments of the present disclosure. The method 400 can be implemented by any electronic device with a computing and display capability. At block 410, the electronic device displays, on a first user interface, a list of items in a current live streaming channel. At block 420, the electronic device receives a first user operation of adding an item in the list of items to a virtual container. At block 430, in response to the first user operation, the electronic device displays, at a bottom of the first user interface, an interactive element for the current live streaming channel, wherein the interactive element indicates that at least one item of the current live streaming channel has been added to the virtual container.

In some embodiments, the interactive element may include a control linked to the virtual container. The method 400 may further include: receiving a second user operation on the control; and in response to the second user operation, displaying a second user interface in which items that have been added to the virtual container are displayed.

In some embodiments, the at least one item of the current live streaming channel is displayed in the second user interface, and each of the at least one item is selected by default for consumption.

In some embodiments, an item from a further live streaming channel different than the current live streaming channel is displayed in the second user interface, and the item from the further live streaming channel is not selected by default.

In some embodiments, the interactive element may further include: benefit information about the current live streaming channel, where the benefit information is used for arousing user interest to trigger the second user operation for the control.

In some embodiments, the benefit information includes at least one of the following: a total price of the at least one item; a number of the at least one item; promotion information of the at least one item; or shipping information of the at least one item.

In some embodiments, the interactive element is a bar element occupying the bottom of the first user interface.

In some embodiments, the interactive element may further include pictures of the at least one item arranged in a partially overlapping manner, and a picture of a most recently added item is arranged on top.

In some embodiments, in response to the first user operation, displaying, at the bottom of the first user interface, the interactive element for the current live streaming channel, may include: causing the interactive element to slide in from the bottom of the first user interface; and displaying, on the first user interface, an animation of an item corresponding to the first user operation falling into the interactive element.

In some embodiments, the virtual container is a cart.

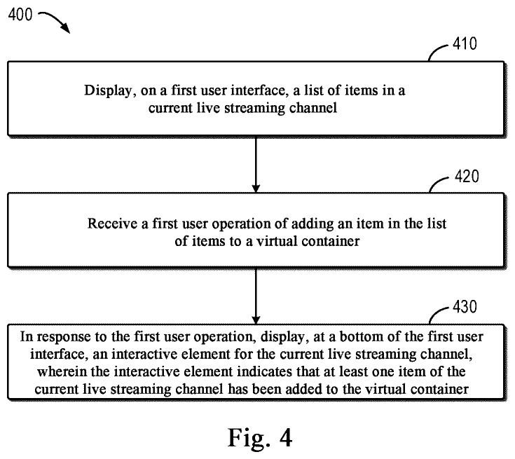

FIG. 5 illustrates an example diagram of an information processing apparatus 500 according to embodiments of the present disclosure. As shown therein, the apparatus 500 include: a display unit 510 configured to display, on a first user interface, a list of items in a current live streaming channel; and a user-operation receiving unit 520 configured to receive a first user operation of adding an item in the list of items to a virtual container, where the display unit 510 is further configured, in response to the first user operation, to display, at a bottom of the first user interface, an interactive element for the current live streaming channel, wherein the interactive element indicates that at least one item of the current live streaming channel has been added to the virtual container.

It is worth noting that more elements as shown in FIGS. 1-3 can be implemented by the apparatus 500 as shown in FIG. 5. For example, the apparatus 500 may include more modules or units to implement the elements described above, or some units or modules shown in FIG. 5 can be further configured to implement the elements described above. Details are omitted herein for brevity.

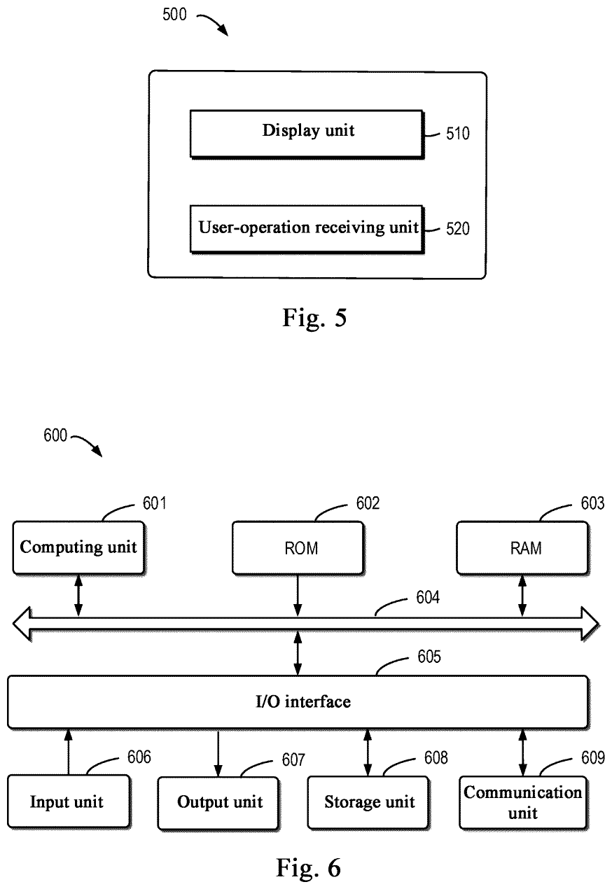

FIG. 6 illustrates an example block diagram of an example device 600 that can implement embodiments of the present disclosure. As shown therein, the device 600 may include a computing unit 601 which can execute various actions and processing based on programs stored in a Read Only Memory (ROM) 602 or a program loaded from a storage unit 606 to a Random Access Memory (RAM) 603. RAM 603 stores therein various programs and data required for operations of the electronic device 600. The computing unit 601, the ROM 602 and the RAM 603 are connected to one another via a bus 604. An input/output (I/O) interface 605 is also connected to the bus 604.

A plurality of components in the device 600 may be connected to the I/O interface 605, including: an input unit 606 including, for example, a touchscreen, a touch pad, a keyboard, a mouse, and the like; an output unit 607 including various types of displays (e.g. an interactive display such as a touchscreen); a storage unit 608 including, for example, a magnetic disk, a compact disc, or the like; and a communication unit 609, for example, a network card, a modem, a wireless communication transceiver, or the like. The communication unit 609 can allow the device 600 to exchange information/data with other devices through a computer network such as Internet, and/or various kinds of telecommunication networks.

The computing unit 601 may be various types of general purpose and/or specific purpose processing components having a processing and computing capability. Some examples of the computing unit 601 include, but are not limited to, a Central Processing Unit (CPU), a Graphics Processing Unit (GPU), various types of specific-purpose Artificial Intelligence (AI) computing chips, various types of computing units having machine learning model algorithms run thereon, a Digital Signal Processor (DSP), any appropriate processor, controller or microcontroller, and the like. The computing unit 601 can execute various methods and processing described above, for example, the method 400. For example, the method 400 may be implemented as computer software programs that are tangibly included in a machine readable medium, e.g., the storage unit 608. In some embodiments, part or all of the computer programs may be loaded and/or mounted onto the device 600 via ROM 602 and/or communication unit 609. When the computer program is loaded to the RAM 603 and executed by the computing unit 601, one or more steps of the method 400 as described above may be executed. Alternatively, in other embodiments, the processing unit 601 may be configured in any other appropriate manners (for example, by means of firmware) to perform the method 400.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the figures. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A method, comprising:
displaying, on a first user interface, a list of items in a current live streaming channel;
receiving a first user operation of adding an item in the list of items to a virtual container;
in response to the first user operation, displaying, at a bottom of the first user interface, an interactive element for the current live streaming channel, wherein the interactive element indicates that at least one item of the current live streaming channel has been added to the virtual container.

2. The method of claim 1, wherein the interactive element comprises a control linked to the virtual container, and wherein the method further comprises:
receiving a second user operation on the control; and
in response to the second user operation, displaying a second user interface in which items that have been added to the virtual container are displayed.

3. The method of claim 2, wherein the at least one item of the current live streaming channel is displayed in the second user interface, and each of the at least one item is selected by default for consumption.

4. The method of claim 2, wherein an item from a further live streaming channel different than the current live streaming channel is displayed in the second user interface, and the item from the further live streaming channel is not selected by default.

5. The method of claim 2, wherein the interactive element further comprises:
benefit information about the current live streaming channel, the benefit information being used for arousing user interest to trigger the second user operation on the control.

6. The method of claim 5, wherein the benefit information comprises at least one of the following:
a total price of the at least one item;
a number of the at least one item;
promotion information of the at least one item; or
shipping information of the at least one item.

7. The method of claim 1, wherein the interactive element is a bar element occupying the bottom of the first user interface.

8. The method of claim 1, wherein the interactive element further comprises pictures of the at least one item arranged in a partially overlapping manner, and a picture of a most recently added item is arranged on top.

9. The method of claim 1, wherein, in response to the first user operation, displaying, at the bottom of the first user interface, the interactive element for the current live streaming channel, comprises:
causing the interactive element to slide in from the bottom of the first user interface; and
displaying, on the first user interface, an animation of an item corresponding to the first user operation falling into the interactive element.

10. The method of claim 1, wherein the virtual container is a cart.

11. An electronic device, comprising:
a processing unit; and
a memory coupled to the processing unit and having instructions stored thereon, wherein the instructions, when executed by the processing unit, cause the electronic device to perform actions, the actions comprising:
displaying, on a first user interface, a list of items in a current live streaming channel;
receiving a first user operation of adding an item in the list of items to a virtual container;
in response to the first user operation, displaying, at a bottom of the first user interface, an interactive element for the current live streaming channel, wherein the interactive element indicates that at least one item of the current live streaming channel has been added to the virtual container.

12. The electronic device of claim 11, wherein the interactive element comprises a control linked to the virtual container, and wherein the actions further comprise:
receiving a second user operation on the control; and
in response to the second user operation, displaying a second user interface in which items that have been added to the virtual container are displayed.

13. The electronic device of claim 12, wherein the at least one item of the current live streaming channel is displayed in the second user interface, and each of the at least one item is selected by default for consumption.

14. The electronic device of claim 12, wherein an item from a further live streaming channel different than the current live streaming channel is displayed in the second user interface, and the item from the further live streaming channel is not selected by default.

15. The electronic device of claim 12, wherein the interactive element further comprises:
benefit information about the current live streaming channel, the benefit information being used for arousing user interest to trigger the second user operation for the control.

16. The electronic device of claim 15, wherein the benefit information comprises at least one of the following:
a total price of the at least one item;
a number of the at least one item;
promotion information of the at least one item; or
shipping information of the at least one item.

17. The electronic device of claim 11, wherein the interactive element is a bar element occupying the bottom of the first user interface.

18. The electronic device of claim 11, wherein the interactive element further comprises pictures of the at least one item arranged in a partially overlapping manner, and a picture of a most recently added item is arranged on top.

19. The electronic device of claim 11, wherein, in response to the first user operation, displaying, at the bottom of the first user interface, the interactive element for the current live streaming channel, comprises:
causing the interactive element to slide in from the bottom of the first user interface; and
displaying, on the first user interface, an animation of an item corresponding to the first user operation falling into the interactive element.

20. A non-transitory computer storage medium comprising computer executable instructions, wherein the computer executable instructions, when executed by a device, cause the device to perform the following actions:
displaying, on a first user interface, a list of items in a current live streaming channel;
receiving a first user operation of adding an item in the list of items to a virtual container;
in response to the first user operation, displaying, at a bottom of the first user interface, an interactive element for the current live streaming channel, wherein the interactive element indicates that at least one item of the current live streaming channel has been added to the virtual container.
